(19) United States
(12) Patent Application Publication
(10) Pub. No.: US 2010/0261603 A1
(43) Pub. Date: Oct. 14, 2010

(54) METHOD FOR THE PRODUCTION OF A SHELL CATALYST LOADED WITH PD AND/OR AU

(75) Inventors: Alfred Hagemeyer, Bad Aibling (DE); Gerhard Mestl, Munchen (DE); Peter Scheck, Gilching (DE)

Correspondence Address: RATNERPRESTIA, P.O. BOX 980, VALLEY FORGE, PA, 19482, US

(73) Assignee: Sud-Chemie AG, Munchen (DE)

(21) Appl. No.: 12/601,900

(22) PCT Filed: May 30, 2008
(86) PCT No.: PCT/EP08/04334

§ 371 Date: May 6, 2010

(30) Foreign Application Priority Data
May 31, 2007 (DE) 10 2007 025 358.5

(51) Int. Cl. B01J 23/44; B01J 23/52

(52) U.S. Cl. 502/339; 502/344

(57) ABSTRACT

The present invention relates to a process for the production of a shell catalyst which comprises a catalyst support shaped body with an outer shell in which metallic Pd and/or Au is contained. In order to provide a process by means of which shell catalysts can be obtained, in the outer shell of which relatively high metallic Pd and/or Au contents are contained, a process is proposed comprising the steps of
a) providing a porous catalyst support shaped body;
b) providing a first solution in which a Pd and/or an Au precursor compound is contained;
c) providing a second solution in which a Pd and/or a Au precursor compound is contained, wherein the first solution brings about a precipitation of the noble-metal component(s) of the second solution and the second solution a precipitation of the noble-metal component(s) of the first solution;
d) loading the catalyst support shaped body with the first and with the second solution;
e) converting the noble-metal component(s) precipitated on the catalyst support body into the metal form.

### CROSS REFERENCE TO RELATED APPLICATIONS

This is a U.S. National Phase application of PCT application number PCT/EP2008/004334, filed May 30, 2008, which claims priority benefit of German application number DE 10 2007 025 358.5 (filed May 31, 2007), the content of such applications being incorporated herein by reference.

### FIELD OF THE INVENTION

The present invention relates to a method for the production of a shell catalyst which comprises a catalyst support shaped body with an outer shell in which metallic Pd and/or Au is contained.

### BACKGROUND OF THE INVENTION

Vinyl acetate monomer (VAM) is an important monomer building block in the synthesis of plastic polymers. The main fields of use of VAM are i.a. the preparation of polyvinyl acetate, polyvinyl alcohol and polyvinyl acetal and also co- and terpolymerization with other monomers such as for example ethylene, vinyl chloride, acrylate, maleinate, fumarate and vinyl laurate.

VAM is prepared predominantly in the gas phase from acetic acid and ethylene by reaction with oxygen, wherein the catalysts used for this synthesis preferably contain Pd and Au as active metals and also an alkali metal component as promoter, preferably potassium in the form of the acetate. In the Pd/Au system of these catalysts, the active metals Pd and Au are probably not present in the form of metal particles of the respective pure metal, but rather in the form of Pd/Au-alloy particles of possibly different composition, although the presence of unalloyed particles cannot be ruled out. As an alternative to Au, for example Cd or Ba can also be used as second active metal component.

Currently, VAM is predominantly prepared by means of so-called shell catalysts in which the catalytic active metals of the catalyst do not fully penetrate the catalyst support, but rather are contained only in an outer area (shell) of greater or lesser width of the catalyst support (cf. on this EP 565 952 A1, EP 634 214 A1, EP 634 209 A1 and EP 634 208 A1), while the areas of the support lying further inside are almost free of noble metals. A more selective VAM synthesis is possible by means of Pd/Au shell catalysts than with catalysts in which the supports are loaded into the core of the support with the noble metals (“impregnated through”).

Pd/Au shell catalysts are usually prepared by the so-called chemical route in which the catalyst support is soaked with solutions of corresponding metal precursor compounds, for example by dipping the support into the solutions, or by means of the incipient wetness method (pore-filling method) in which the support is loaded with a volume of solution corresponding to its pore volume.

A Pd/Au shell catalyst is prepared for example by first soaking a catalyst support shaped body with a first step in an Na₂PdCl₄ solution and then in a second step fixing (precipitating) the Pd component with NaOH solution onto the catalyst support in the form of a Pd-hydroxide compound. In a subsequent, separate third step, the catalyst support is then soaked with an NaAuCl₄ solution and then the Au component is likewise fixed (precipitated) by means of NaOH. After the fixing of the noble-metal components in an outer shell of the catalyst support, the catalyst support loaded with noble-metal hydroxides is then very largely washed free of chloride and Na ions, then dried and finally reduced with ethylene at 150° C. The thus-produced Pd/Au shell is usually approximately 100 to 500 μm thick.

Usually, the catalyst support loaded with the noble metals is then loaded with potassium acetate after the hydroxide fixing or the reduction of the noble-metal components wherein, rather than the loading with this promoter taking place only in the outer shell of the support loaded with noble metals, the catalyst support is completely impregnated through with the promoter.

According to the state of the art, the active metals Pd and Au, starting from chloride compounds are precipitated onto the support as hydroxides, and thereby fixed to same. However, this technique has reached the limits of what is possible as regards maximum noble-metal loadings. In particular the Au fixing has disadvantages, such as long action times of the base in order to induce the precipitation of the stable Au tetrachloro complex, incomplete precipitation and concomitant inadequate Au retention.

### SUMMARY OF THE INVENTION

Therefore, an object of the present invention is to provide a method by means of which shell catalysts can be obtained in the outer shell of which relatively high metallic Pd and/or Au contents are contained.

This object is achieved by a method comprising the steps of
a) providing a porous catalyst support shaped body;
b) providing a first solution in which a Pd and/or an Au precursor compound is contained;
c) providing a second solution in which a Pd and/or a Au precursor compound is contained, wherein the first solution brings about a precipitation of the noble-metal component(s) of the second solution and the second solution a precipitation of the noble-metal component(s) of the first solution;
d) loading the catalyst support shaped body with the first and with the second solution;
e) converting the noble-metal component(s) precipitated on the catalyst support body into the metal form.

It has been established that by means of the method according to aspects of the invention shell catalysts with high Pd, Au or Pd and Au content in the outer shell can be obtained.

Also, by means of the method according to aspects of the invention, Pd/Au shell catalysts with a relatively thin noble-metal shell can be produced, wherein the Au is largely uniformly thoroughly mixed with Pd over the thickness of the shell.

The concept according to aspects of the invention includes the use of two incompatible solutions, of which the one solution brings about the precipitation of the noble-metal component of the other solution and vice versa. For example, the solutions are deposited onto the catalyst support by firstly impregnating the support with the first and then with the other solution. When the latter of the two solutions are deposited, the two solutions are combined on the support, thus bringing about the precipitation of the noble-metal components of the precursor compounds without a separate precipitation step needing to be carried out.

The concept of the use of incompatible solutions can, where there is rapid precipitation of the metal components (immobilization/fixing) because of the concomitant shortened diffusion time, lead to thinner shells than is possible when using conventional solutions compatible with one another.

By means of the concept of the use of incompatible solutions, shell catalysts with high noble-metal contents and thin shells can be obtained. Also, the method according to aspects of the invention shows an improved metal retention and a faster and more complete precipitation of the noble metals and a simultaneous precipitation of Pd and Au in only one step, which can lead to an intimate Pd/Au thorough mixing. Also, when applying the method according to aspects of the invention NaOH costs can be saved and NaOH handling dispensed with, wherein additionally the mechanical weakening of the support due to the usual base treatment can also be avoided. In particular, high Au contents with an Au/Pd atomic ratio of 0.5 and more, which is very desirable with regard to the increase in VAM selectivity, can be easily achieved by means of the principle of the incompatible solutions.

According to a preferred embodiment of the method according to aspects of the invention, it is provided that the first solution is acid and the second solution basic or that the first solution is basic and the second solution acid. It was found that if one incompatible solution is acid and the other basic this can lead to an almost complete precipitation of the noble-metal components. Acid solutions can for example be prepared by dissolving a metal salt in acid (e.g. PdCl₂+2HCl(H₂O)→H₂PdCl₄) and base metal-salt solutions by dissolving a metal salt in a base solution (e.g. Au(OH)₃+KOH(H₂O)→KAuO₂).

According to a further preferred embodiment of the method according to aspects of the invention it can be provided that the first solution is the solution of (an) acid/acid noble-metal precursor compounds) and the second solution the solution of (a) base/base noble-metal precursor compound(s) or that the first solution is the solution of (a) base/base noble-metal precursor compound(s) and the second solution is the solution of (an) acid/acid noble-metal precursor compound(s). Acid and base solutions containing a noble-metal precursor compound can be prepared particularly simply and cheaply by dissolving a corresponding acid or base noble-metal salt compound in an aqueous solvent. Within the framework of the present invention, by acid or base metal-salt compound is meant a Pd or Au salt compound which when dissolved in pure water reacts acid or basic, which can be seen in a reduction or increase in the pH.

Examples of preferred Pd precursor compounds are water-soluble Pd salts. According to a particularly preferred embodiment of the method according to aspects of the invention, the Pd precursor compound is selected from the group consisting of Pd(NH₃)₄(OH)₂, Pd(NH₃)₄(OAc)₂, H₂PdCl₄, Pd(NH₃)₄(HCO₃)₂, Pd(NH₃)₄(HPO₄), Pd(NH₃)₄Cl₂, Pd(NH₃)₄ oxalate, Pd(NO₃)₂, Pd(NH₃)₄(NO₃)₂, K₂Pd(OAc)₂(OH)₂, Na₂Pd(OAc)₂(OH)₂, Pd(NH₃)₂(NO₂)₂, K₂Pd(NO₂)₄, Na₂Pd(NO₂)₄, Pd(OAc)₂, K₂PdCl₄, (NH₄)₂PdCl₄, Pd oxalate, ammonium Pd oxalate, PdCl₂, K₂PdCl₄ and Na₂PdCl₄, wherein mixtures of two or more of the above-named salts can also be used.

Examples of preferred Au precursor compounds are water-soluble Au salts. According to a particularly preferred embodiment of the method according to aspects of the invention the Au precursor compound is selected from the group consisting of KAuO₂, HAuCl₄, KAu(NO₂)₄, AuCl₃, NaAuCl₄, KAuCl₄, (NH₄)AuCl₄, KAu(OAc)₃(OH), HAu(NO₃)₄, NaAuO₂, NMe₄AuO₂, RbAuO₂, CsAuO₂, NaAu(OAc)₃(OH), RbAu(OAc)₃OH, CsAu(OAc)₃OH, NMe₄Au(OAc)₃OH and Au(OAc)₃, wherein mixtures of two or more of the above-named salts can also be used. It is optionally advisable in each case to freshly prepare the Au(OAc)₃ or KAuO₂ by precipitating the oxide/hydroxide from a gold acid solution, washing and isolating the precipitate and also taking up same in acetic acid or KOH in each case.

Suitable aqueous solutions of Pd precursor compounds for the concept of the incompatible solutions are listed by way of example in Table 1.

TABLE 1

| Precursor compound | Character of the solution |
|---|---|
| PdCl₂ | acid |
| Pd(NH₃)₂(NO₂)₂ | basic |
| Na₂PdCl₄ | neutral |
| Pd(NH₃)₄(OH)₂ | basic |
| Pd(NO₃)₂ | acid |
| K₂Pd(OAc)₂(OH)₂ | basic through dissolution of palladium |
| | acetate in KOH |

If, with regard to a premature Au reduction, NH₃ were to have too strong a reductive effect, the corresponding diamine complexes can also be used with ethylenediamine as ligand or the corresponding ethanol amine complexes instead of the palladium amine complexes.

Suitable aqueous solutions of Au precursor compounds for the concept of the incompatible solutions are listed by way of example in Table 2.

TABLE 2

| Precursor compound | Character of the solution |
|---|---|
| AuCl₃ | acid |
| KAuO₂ | basic through dissolution of Au(OH)₃ in |
| | KOH |
| NaAuCl₄ | neutral |
| HAuCl₄ | acid |
| KAu(OAc)₃(OH) | basic through dissolution of Au(OAc)₃ in |
| | KOH |
| HAu(NO₃)₄ | acid (stable in semi-concentrated HNO₃) |

Suitable combinations of incompatible solutions for the base-free precipitation of the noble-metal components are for example a PdCl₂ and a KAuO₂ solution; a Pd(NO₃)₂ and a KAuO₂ solution; a Pd(NH₃)₄(OH)₂ and an AuCl3 or HAuCl4 solution.

According to the method according to aspects of the invention Pd can also be precipitated with incompatible Pd solutions and analogously Au with incompatible Au solutions, e.g. by bringing a PdCl₂ solution into contact with a Pd(NH₃)₄(OH)₂ solution or an HAuCl₄ with a KAuO₂ solution. In this way high Pd and/or Au contents can precipitate in a shell without having to use highly-concentrated metal-salt solutions.

According to aspects of the invention a mixed solution containing compounds of Pd and Au which for noble-metal precipitation is brought into contact with a noble-metal solution incompatible with the mixed solution can also be used. An example of a mixed solution is a PdCl₂ and AuCl₃-containing solution, the noble-metal components of which can be precipitated with a KAuO₂ solution, or a Pd(NH₃)₄(OH)₂ and KAuO₂-containing solution, the noble-metal components of which can be precipitated with a PdCl₂ and HAuCl₄-containing solution.

All pure solvents or solvent mixtures in which the selected precursor compounds are soluble and which, after deposition onto the catalyst support, can be easily removed again from same by means of drying are suitable as solvents for the precursor compounds. Preferred solvent examples for the metal acetates as precursor compound are above all acetone or unsubstituted carboxylic acids, in particular acetic acid, and acetone, and for the metal chlorides above all water or dilute hydrochloric acid.

If the precursor compounds are not sufficiently soluble in acetic acid, water or dilute hydrochloric acid or mixtures thereof, other solvents can also be used as an alternative or in addition to the named solvents. Solvents which are inert and miscible with acetic acid or water preferably come into consideration as other solvents in this case. Ketones, for example acetone or acetylacetone, furthermore ethers, for example tetrahydrofuran or dioxan, acetonitrile, dimethylformamide and solvents based on hydrocarbons such as for example benzene may be named as preferred solvents which are suitable for adding to acetic acid.

Ketones, for example acetone, or alcohols, for example ethanol or isopropanol or methoxyethanol, lyes, such as aqueous KOH or NaOH, or organic acids, such as acetic acid, formic acid, citric acid, tartaric acid, malic acid, glyoxylic acid, glycolic acid, oxalic acid, pyruvic acid, oxamic acid, lactic acid or amino acids such as glycine, may be named as preferred solvents and additives which are suitable for adding to water.

If chloride compounds are used as precursor compounds, it must be ensured that the chloride ions are reduced to a tolerable residual quantity before using the catalyst produced according to the method according to invention, since chloride is a catalyst poison for the metals Pd and Au. For this, the catalyst support is as a rule washed with plenty of water after the fixing of the Pd and Au components. This generally happens either immediately after precipitation of the Pd and Au components or after the reduction of the precipitated noble-metal components to the respective metal.

However, according to a preferred embodiment of the method according to aspects of the invention, chloride-free Pd and Au precursor compounds are used as well as chloride-free solvents to keep the chloride content in the catalyst as low as possible and avoid a laborious washing free of chloride. The corresponding acetate, hydroxide, nitrite, nitrate or hydrogen carbonate compounds are preferably used as precursor compounds, as they contaminate the catalyst with chloride to only a very small extent.

The loading of the support with the precursor compounds in the area of an outer shell can be achieved according to per se known methods. Thus the incompatible supports can be loaded by soaking, for example by dipping the support into the precursor solutions or soaking it according to the incipient wetness method. According to a further preferred embodiment of the method according to aspects of the invention it is therefore provided that the catalyst support is loaded with the first and with the second solution by soaking the catalyst support with the two solutions.

According to a further preferred embodiment of the method according to aspects of the invention the incompatible solutions can however also be applied to the support by means of so-called physical methods. In these, the loading of the support with the incompatible solutions is carried out preferably by spray impregnation, because a particularly uniform loading of the shell of the support with the precursor compounds is thus possible. The incompatible solutions can be sprayed successively or simultaneously by means of a single-product nozzle or a dual-product nozzle or several single-product nozzles, wherein the catalyst support is circulated, during the spraying, for example by means of a coating drum into which e.g. hot air can also be blown in order to rapidly evaporate the solvent.

According to a particularly preferred embodiment of the method according to aspects of the invention, it is provided that the incompatible solutions are deposited onto the catalyst support by spraying the solutions onto a fluid bed or a fluidized bed of the catalyst support, preferably by means of an aerosol of the solutions. The shell thickness of the resulting catalyst can thereby be adjusted and optimized, for example up to a thickness of 2 mm. But even very thin shells with a thickness of less than 100 μm are thus possible.

The thickness of a noble-metal shell can for example be measured visually by means of a microscope. The area in which the noble metals are deposited appears black, while the areas free of noble metals appear white. As a rule, the boundary between areas containing noble metals and areas free of them is very sharp and can clearly be recognized visually. If the above-named boundary is not sharply defined and accordingly not clearly recognizable visually, the thickness of the shell corresponds to the thickness of a shell, measured starting from the outer surface of the catalyst support, which contains 95% of the noble metal deposited on the support.

The above-named embodiment of the method according to aspects of the invention can be carried out using a fluid bed or fluidized bed unit. A fluidized bed unit in which a so-called controlled air-glide layer can be produced, is particularly preferred. For one thing, the catalyst supports are thoroughly mixed by the controlled air-glide layer, wherein they simultaneously rotate about their own axis, whereby they are dried evenly by the process air. For another, due to the consequent orbital movement, effected by the controlled air-glide layer, of the shaped bodies the catalyst supports pass through the spray procedure (application of the incompatible solutions) at a virtually constant frequency. A largely uniform shell thickness of a treated batch of shaped bodies is thereby achieved. A further result is that the noble-metal concentration varies only relatively little over a relatively large area of the shell thickness, i.e. such that the noble-metal concentration describes an approximately distorted rectangular function with a high metal accumulation outside and approximately lower metal enhancement inside over a large area of the shell thickness, whereby a largely uniform activity of the resulting catalyst is ensured over the thickness of the Pd/Au shell.

Suitable coating drums, fluid bed units and fluidized bed units for carrying out the method according to aspects of the invention according to preferred embodiments are known in the state of the art and sold e.g. by Heinrich Brucks GmbH (Alfeld, Germany), ERWEK GmbH (Heusenstamm, Germany), Stechel (Germany), DRIAM Anlagenbau GmbH (Eriskirch, Germany), Glatt GmbH (Binzen, Germany), G.S. Divisione Verniciatura (Osteria, Italy), HOFER-Pharma Maschinen GmbH (Weil am Rhein, Germany), L. B. Bohle Maschinen+Verfahren GmbH (Enningerloh, Germany), Lödige Maschinenbau GmbH (Paderborn, Germany), Manesty (Merseyside, United Kingdom), Vector Corporation (Marion, Iowa, USA), Aeromatic-Fielder AG (Bubendorf, Switzerland), GEA Process Engineering (Hampshire, United Kingdom), Fluid Air Inc. (Aurora, Ill., USA), Heinen Systems GmbH (Varel, Germany), Hüttlin GmbH (Steinen, Germany), Umang Pharmatech Pvt. Ltd. (Marharashtra, India) and Innojet Technologies (Lörrach, Germany).

In particular the fluid bed devices called Innojet® Aircoater or Innojet® Ventilus from Innojet are particularly preferred. By means of these devices, fluid beds of elliptically or toroidally circulating catalyst support shaped bodies can be produced easily in terms of process engineering. To give an idea of how the shaped bodies move in such fluidized beds, it may be stated that in the case of “elliptical circulation” the catalyst support shaped bodies move in the fluidized bed in a vertical plane on an elliptical path, the size of the major and minor axis changing. In the case of “toroidal circulation” the catalyst support shaped bodies move in the fluidized bed in the vertical plane on an elliptical path, the size of the major and minor axis changing, and in the horizontal plane on a circular path, the size of the radius changing. On average, the shaped bodies move in the case of “elliptical circulation” in the vertical plane on an elliptical path, in the case of “toroidal circulation” on a toroidal path, i.e. the movement path of a shaped body covers the surface of a torus helically with a vertically elliptical section. A particularly even impregnation with the incompatible solutions and thereby a particularly even shell thickness can be obtained by this circular movement of the support in the fluidized bed.

According to a further preferred embodiment of the method according to aspects of the invention the catalyst support is heated during the application of the incompatible solutions. This can be achieved for example by means of heated process air which is used to produce the fluid or fluidized bed. The drying-off speed of the deposited solutions of the noble-metal precursor compounds can be determined via the degree of heating of the catalyst supports. At relatively low temperatures the drying-off speed is for example relatively low, with the result that with a corresponding quantitative deposition, greater shell thicknesses can be formed because of the high diffusion of the precursor compounds that is caused by the presence of solvent. At relatively high temperatures, on the other hand, the drying-off speed is relatively high, with the result that solution coming into contact with the shaped body dries off more quickly, which is why solution deposited on the catalyst support cannot penetrate deep into the latter. At relatively high temperatures relatively small shell thicknesses can thus be obtained with a high noble-metal loading.

The catalyst support used in the method according to aspects of the invention is formed as a shaped body. The catalyst support can in principle assume the form of any geometric body to which a corresponding noble metal shell can be applied. However, it is preferred if the catalyst support is formed as a sphere, cylinder (also with rounded end surfaces), perforated cylinder (also with rounded end surfaces), trilobe, “capped tablet”, tetralobe, ring, doughnut, star, cartwheel, “reverse” cartwheel, or as a strand, preferably as a ribbed strand or star strand, preferably as a sphere.

The diameter or the length and thickness of the catalyst support is preferably 2 to 9 mm, depending on the geometry of the reactor tube in which the catalyst being produced is to be used.

Directly after the fixing of the noble-metal components the support can be calcined to convert the precipitated noble-metal compounds into the corresponding oxides. Calcining takes place preferably at temperatures of less than 700° C., particularly preferably between 300-450° C. in the presence of air. The calcining time depends on the calcining temperature and is preferably chosen in the range of 0.5-6 hours. At a calcining temperature of approx. 400° C., the calcining time is preferably 1-2 hours. At a calcining temperature of 300° C., the calcining time is preferably up to 6 hours. A preferred embodiment comprises the (intermediate) calcination of the Pd-loaded support at approx. 400° C. for PdO formation followed by an Au deposition and reduction, whereby an Au sintering can be avoided.

The noble-metal components are further reduced before the use of the catalyst, wherein the reduction can be carried out in situ, i.e. in the process reactor, or also ex situ, i.e. in a special reduction reactor. Reduction in situ is preferably carried out with ethylene (5 vol.-%) in nitrogen at a temperature of approx. 150° C. over a period of for example 5 hours. Reduction ex situ can be carried out for example with 5 vol.-% hydrogen in nitrogen, for example by means of forming gas, at temperatures in the range of preferably 150-500° C. over a period of 5 hours.

Gaseous or vaporable reducing agents such as for example CO, NH₃, formaldehyde, methanol and hydrocarbons can likewise be used, wherein the gaseous reducing agents can also be diluted with inert gas, such as for example carbon dioxide, nitrogen or argon. A reducing agent diluted with inert gas is preferably used. Mixtures of hydrogen with nitrogen or argon, preferably with a hydrogen content between 1 vol.-% and 15 vol.-%, are preferred.

The reduction of the noble metals can also be undertaken in the liquid phase, preferably by means of the reducing agents hydrazine, K-formate, Na-formate, ammonium formate, formic acid, K-hypophosphite, hypophosphoric acid, H₂O₂, or Na-hypophosphite.

The quantity of reducing agent is preferably chosen such that during the treatment period at least the equivalent required for complete reduction of the noble-metal components is passed over the forming catalyst. Preferably, however, an excess of reducing agent is passed over the catalyst in order to ensure a rapid and complete reduction.

The reduction is preferably pressureless, i.e. at an absolute pressure of approx. 1 bar. For the production of industrial quantities of catalyst according to aspects of the invention a rotary tube oven or fluid bed or fluidized bed reactor is preferably used in order to ensure an even reduction of the catalyst.

According to a preferred embodiment of the method according to aspects of the invention, the method comprises the steps:
a) providing a porous catalyst support shaped body, preferably comprising a natural sheet silicate;
b) providing a first solution in which Na₂PdCl₄ and/or K₂PdCl₄ is contained dissolved, HAuCl₄, NaAuCl₄ and/or KAuCl₄, or Na₂PdCl₄ and/or K₂PdCl₄ and HAuCl₄ and/or KAuCl₄;
c) providing a second solution in which Pd(NH₃)₄(OH)₂, NaAuO₂ and/or KAuO₂ or Pd(NH₃)₄(OH)₂ and NaAuO₂ and/or KAuO₂ are contained dissolved;
d) impregnating the catalyst support shaped body with the first and with the second solution;
e) converting the noble-metal component(s) precipitated on the catalyst support body into the metal form.

The following embodiment examples serve to illustrate the invention.

### EXAMPLE 1

20 g catalyst support shaped body from Süd-Chemie AG called KA-160 (geometric form: spheres; diameter: 5 mm; material: calcined acid-treated bentonite) was impregnated by means of the incipient wetness method with a solution prepared from 0.59 g of a 17.9% (relative to Pd) Na₂PdCl₄ solution and 10.41 g water.

After the solution had been taken up by the shaped bodies, the solution was left for a further 10 min to act on the supports. The supports were then dried for a period of 22 h at a temperature of 80° C.

After drying the supports were impregnated by means of the incipient wetness method with a solution prepared from 3.4 g of a 4.5% (relative to Pd) Pd(NH₃)₄(OH)₂ solution and 8.32 g water. After the solution had been taken up by the shaped bodies, the solution was left for a further 1 h to act on the supports.

The supports were then dried for a period of 22 h at a temperature of 80° C. and the Pd component reduced by means of 5 vol.-% hydrogen in nitrogen at a temperature of 350° C. for a period of 5 h.

The noble-metal shell of the thus-produced shell catalysts has a thickness of 318 μm on average. The Pd content of the supports loaded with noble metal is 1.19 wt.-% (determined by elemental analysis by means of inductively coupled plasma (ICP)).

### EXAMPLE 2

20 g catalyst support shaped body from Süd-Chemie AG called KA-160 (see example 1) was impregnated by means of the incipient wetness method with a solution prepared from 0.9 g of a 17.9% (relative to Pd) Na₂PdCl₄ solution and 10.26 g water.

After the solution had been taken up by the shaped bodies, the solution was left for a further 10 min to act on the supports. The supports were then dried for a period of 20 h at a temperature of 80° C.

After drying the supports were impregnated by means of the incipient wetness method with a solution prepared from 1.77 g of a 4.5% (relative to Pd) Pd(NH₃)₄(OH)₂ solution and 9.38 g water. After the solution had been taken up by the shaped bodies, the solution was left for a further 15 min to act on the supports.

The supports were then dried for a period of 22 h at a temperature of 80° C. and the Pd component reduced by means of 5 vol.-% hydrogen in nitrogen at a temperature of 350° C. for a period of 5 h.

The noble-metal shell of the thus-produced shell catalysts has a thickness of 173 μm on average. The Pd content of the supports loaded with noble metal is 1.13 wt.-% (determined by means of ICP).

### EXAMPLE 3

10 g catalyst support shaped body from Süd-Chemie AG called KA-160 (see example 1) was impregnated by means of the incipient wetness method with a solution prepared from 0.04 g of a 41.81% (relative to Pd) HauCl₄ solution and 5.47 g water.

After the solution had been taken up by the shaped bodies, the solution was left for a further 30 min to act on the supports. The supports were then dried for a period of 20 h at a temperature of 80° C.

After drying the supports were impregnated by means of the incipient wetness method with a solution prepared from 3.48 g of a 1.5% (relative to Pd) KauO₂ solution and 1.51 g water. After the solution had been taken up by the shaped bodies, the solution was left for a further 30 min to act on the supports.

The supports were then dried for a period of 23 h at a temperature of 80° C. and the Au component reduced by means of 5 vol.-% hydrogen in nitrogen at a temperature of 350° C. for a period of 5 h.

The noble-metal shell of the thus-produced shell catalysts has a thickness of 309 μm on average. The Au content of the supports loaded with noble metal is 0.78 wt.-% (determined by means of ICP).

### EXAMPLE 4

10 g catalyst support shaped body from Süd-Chemie AG called KA-160 (see example 1) was impregnated by means of the incipient wetness method with a solution prepared from 0.46 g of a 17.9% (relative to Pd) Na₂PdCl₄ solution and 5.13 g water.

After the solution had been taken up by the shaped bodies, the solution was left for a further 30 min to act on the supports. The supports were then dried for a period of 19.5 h at a temperature of 80° C.

After drying the supports were impregnated by means of the incipient wetness method with a solution prepared from 0.89 g of a 4.5% (relative to Pd) Pd(NH₃)₄(OH)₂ solution and 4.70 g water. After the solution had been taken up by the shaped bodies, the solution was left for a further 30 min to act on the supports.

The supports were then dried for a period of 23.5 h at a temperature of 80° C.

After the second drying the supports were impregnated by means of the incipient wetness method with a solution prepared from 0.03 g of a 41.81% (relative to Au) HauCl4 solution and 5.27 g water.

After the solution had been taken up by the shaped bodies, the solution was left for a further 30 min to act on the supports. The supports were then dried for a period of 20 h at a temperature of 80° C.

After the third drying the supports were impregnated by means of the incipient wetness method with a solution prepared from 3.87 g of a 1.5% (relative to Au) KauO₂ solution and 1.64 g water. After the solution had been taken up by the shaped bodies, the solution was left for a further 30 min to act on the supports.

The supports were then dried for a period of 72 h at a temperature of 80° C. and the noble-metal components reduced by means of 5 vol.-% hydrogen in nitrogen at a temperature of 350° C. for a period of 5 h.

The noble-metal shell of the thus-produced shell catalysts has a thickness of 247 μm on average. The Pd content of the supports loaded with noble metal is 1.12 wt.-% and the Au content 0.72 wt.-% (determined by means of ICP).

### EXAMPLE 5

10 g catalyst support shaped body from Süd-Chemie AG called KA-160 (see example 1) was impregnated by means of the incipient wetness method with a solution prepared from 0.44 g of a 17.9% (relative to Pd) Na₂PdCl₄ solution and 5.16 g water.

After the solution had been taken up by the shaped bodies, the solution was left for a further 30 min to act on the supports. The supports were then dried for a period of 19.0 h at a temperature of 80° C.

After drying the supports were impregnated by means of the incipient wetness method with a solution prepared from 0.88 g of a 4.5% (relative to Pd) Pd(NH₃)₄(OH)₂ solution and 4.69 g water. After the solution had been taken up by the shaped bodies, the solution was left for a further 30 min to act on the supports.

The supports were then dried for a period of 23 h at a temperature of 80° C.

After the second drying the supports were impregnated by means of the incipient wetness method with a solution prepared from 0.04 g of a 41.81% (relative to Au) HauCl₄ solution and 5.27 g water.

After the solution had been taken up by the shaped bodies, the solution was left for a further 30 min to act on the supports. The supports were then dried for a period of 20 h at a temperature of 80° C.

After the third drying the supports were impregnated by means of the incipient wetness method with a solution prepared from 3.87 g of a 1.5% (relative to Au) KauO₂ solution and 1.63 g water. After the solution had been taken up by the shaped bodies, the solution was left for a further 30 min to act on the supports.

The supports were then dried for a period of 72 h at a temperature of 80° C. and the noble-metal components reduced by means of 5 vol.-% hydrogen in nitrogen at a temperature of 350° C. for a period of 5 h.

The noble-metal shell of the thus-produced shell catalysts has a thickness of 247 μm on average. The Pd content of the supports loaded with noble metal is 1.08 wt.-% and the Au content 0.8 wt.-% (determined by means of ICP).

1. Method for the production of a shell catalyst which comprises a catalyst support shaped body with an outer shell in which metallic Pd and/or Au is contained, comprising the steps of
a) providing a porous catalyst support shaped body;
b) providing a first solution in which a Pd and/or an Au precursor compound is contained;
c) providing a second solution in which a Pd and/or a Au precursor compound is contained, wherein the first solution brings about a precipitation of the noble-metal component(s) of the second solution and the second solution a precipitation of the noble-metal component(s) of the first solution;
d) loading the catalyst support shaped body with the first and with the second solution;
e) converting the noble-metal component(s) precipitated on the catalyst support body into the metalic form.

2. Process according to claim 1, characterized in that the first solution is acid and the second solution basic or that the first solution is basic and the second solution is acid.

3. Process according to claim 1, characterized in that the first solution is the solution of an acid/acid noble-metal precursor compound(s) and the second solution the solution of a base/base noble-metal precursor compound(s) or that the first solution is the solution of a base/base noble-metal precursor compound(s) and the second solution is the solution of an acid/acid noble-metal precursor compound(s).

4. Process according to claim 1, characterized in that the Pd precursor compound is selected from the group consisting of Pd(NH₃)₄(OH)₂, Pd(NH₃)₄(OAc)₂, H₂PdCl₄, Pd(NH₃)₄(HCO₃)₂, Pd(NH₃)₄), Pd(NH₃)₄Cl₂, Pd(NH₃)₄ oxalate, Pd(NO₃)₂, Pd(NH₃)₄(NO₃)₂, K₂Pd(OAc)₂(OH)₂, Na₂Pd(OAc)₂(OH)₂, Pd(NH₃)₂(NO₂)₂, K₂Pd(NO₂)₄, Na₂Pd(NO₂)₄, Pd(OAc)₂, PdCl₂, K₂PdCl₄ and Na₂PdCl₄.

5. Process according to claim 1, characterized in that the Au precursor compound is selected from the group consisting of KAuO₂, HAuCl₄, KAu(NO₂)₄, NaAu(NO₂)₄, AuCl₃, NaAuCl₄, KAuCl₄, KAu(OAc)₃(OH), HAu(NO₃)₄, NaAuO₂, NMe₄AuO₂, RbAuO₂, CsAuO₂, NaAu(OAc)₃(OH), RbAu(OAc)₃OH, CsAu(OAc)₃OH, NMe₄Au(OAc)₃OH and Au(OAc)₃.

6. Process according to claim 1, characterized in that the catalyst support is loaded with the first and with the second solution, by soaking the catalyst support with the first and in the second solution.

7. Process according to claim 1, characterized in that the catalyst support is loaded with the first and with the second solution by spraying the catalyst support with the first and with the second solution.

8. Process according to claim 7, characterized in that the first and the second solution are sprayed onto a fluidized bed or a fluid bed of catalyst supports, preferably onto a fluid bed of catalyst supports.

9. Process according to claim 8, characterized in that the catalyst supports circulate elliptically or toroidally, preferably toroidally, in the fluid bed.

10. Process according to claim 8, characterized in that the first and the second solution are sprayed onto heated catalyst supports.

11. Process according to claim 1, characterized in that the catalyst support is formed as a sphere, cylinder, perforated cylinder, trilobe, ring, star or as a strand, preferably as a ribbed strand or star strand, preferably as a sphere.

12. Process according to claim 1, characterized in that the catalyst support is formed as a sphere with a diameter greater than 2 mm, preferably with a diameter greater than 3 mm and preferably with a diameter greater than 4 mm.
